(19) United States
(12) Patent Application Publication
(10) Pub. No.: US 2007/0174897 A1
(43) Pub. Date: Jul. 26, 2007

(54) Method and apparatus for protecting data stored in data storage devices

(75) Inventors: Michael A. Rothman, Puyallup, WA (US); Vincent J. Zimmer, Federal Way, WA (US)

Correspondence Address: Lawrence Cho;Attorney at Law, c/o PortfolioIP, P.O. Box 52050, Minneapolis, MN, 55402, US

(73) Assignee: Intel Corporation

(21) Appl. No.: 11/328,628

(22) Filed: Jan. 10, 2006

(51) Int. Cl. H04L 9/32

(52) U.S. Cl. 726/2

(57) ABSTRACT

A method for managing access to a data storage device includes determining whether a request to access more than one non-contiguous sectors in the data storage device is made by an entity having privilege. Whether the more than one non-contiguous sectors is protected is determined. The request to access the more than one non-contiguous sectors is granted in response to whether the entity has privilege and whether the data in the more than one non-contiguous sectors is protected. Other embodiments are described and claimed.

### FIELD

Embodiments of the present invention relate to data protection tools. More specifically, embodiments of the present invention relate to methods and apparatus for protecting access to data stored in input output devices.

### BACKGROUND

As multi-user computer systems are becoming more common in places such as offices, schools, and public locations, the desire to protect and limit access to certain data stored on these computer systems among users has become apparent. Although there are a number of tools and procedures available to allow and disallow access to certain components on a computer system, tools and procedure for managing access to content on input output devices such as hard disks are limited.

One procedure that is available to protect read/write access to sectors of a hard disk drive is known as the Host Protected Area (HPA) (published 2004) defined by Technical Committee T13 Industry Standards Group, which is part of the International Committee on Information Technology Standards (INCITS). HPA is typically used to isolate a selected number of contiguous sectors on a hard disk to store maintenance and recovery programs.

HPA, however, only provides for a single set of continuous sectors or a single region of a hard disk drive to be protected. HPA could not protect, for example, a scatter-gather list of logical block addresses (LBAs) corresponding to a number of files. Other drawbacks associated with HPA include its requirement of having input output devices connected to an integrated drive electronics (IDE) controller. Data stored on input output devices that are not connected to an IDE controller can not be protected. Furthermore, neither HPA nor other available tools or procedures offers a solution to protect data stored on an input output device if the input output device were removed from the computer system.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 illustrates an embodiment of a computer system according to an embodiment of the present invention.

FIG. 2 is a block diagram that illustrates a virtualized environment in which an embodiment of the invention resides according to a first embodiment.

FIG. 3 is a block diagram that illustrates a virtualized environment in which an embodiment of the invention resides according to a second embodiment.

FIG. 4 is a block diagram that illustrates an input output monitor according to an embodiment of the present invention.

FIG. 5 is a flow chart illustrating a method for managing access to an input output device according to a first embodiment of the present invention.

FIG. 6 is a flow chart illustrating a method for managing access to an input output device according to a second embodiment of the present invention.

### DETAILED DESCRIPTION

In the following description, for purposes of explanation, specific nomenclature is set forth to provide a thorough understanding of embodiments of the present invention. It will be apparent to one skilled in the art that specific details in the description may not be required to practice the embodiments of the present invention. In other instances, well-known circuits, devices, and programs are shown in block diagram form to avoid obscuring embodiments of the present invention unnecessarily.

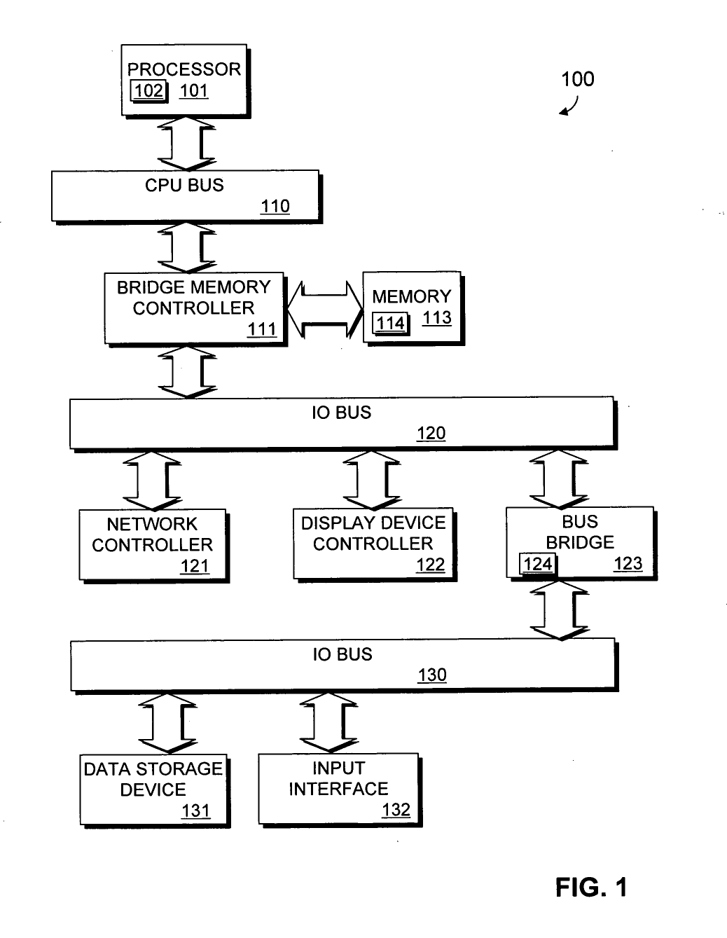

FIG. 1 is a block diagram of an exemplary computer system 100 according to an embodiment of the present invention. The computer system 100 includes a processor 101. The processor 101 may be a complex instruction set computer microprocessor, a reduced instruction set computing microprocessor, a very long instruction word microprocessor, a processor implementing a combination of instruction sets, or other processor device. FIG. 1 shows the computer system 100 with a single processor. However, it is understood that the computer system 100 may operate with one or more processors or one or more multi-core processors. Additionally, each of the one or more processors may support one or more hardware threads. The processor 101 is coupled to a CPU bus 110 that transmits data signals between processor 101 and other components in the computer system 100.

The computer system 100 includes a memory 113. The memory 113 may be a dynamic random access memory device, a static random access memory device, read-only memory, and/or other memory device. The memory 113 may store instructions and code represented by data signals that may be executed by the processor 101. A cache memory 102 may reside inside processor 101 that stores data signals stored in memory 113. The cache 102 speeds access to memory by the processor 101 by taking advantage of its locality of access. In an alternate embodiment of the computer system 100, the cache resides external to the processor 101. A bridge memory controller 111 is coupled to the CPU bus 110 and the memory 113. The bridge memory controller 111 directs data signals between the processor 101, the memory 113, and other components in the computer system 100 and bridges the data signals between the CPU bus 110, the memory 113, and input output (IO) bus 120.

The IO bus 120 may be a single bus or a combination of multiple buses. The IO bus 120 provides communication links between components in the computer system 100. A network controller 121 is coupled to the IO bus 120. The network controller 121 may link the computer system 100 to a network of computers (not shown) and support communication among the machines. A display device controller 122 is coupled to the IO bus 120. The display device controller 122 allows coupling of a display device (not shown) to the computer system 100 and acts as an interface between the display device and the computer system 100.

IO bus 130 may be a single bus or a combination of multiple buses. IO bus 130 provides communication links between components in the computer system 100. A data storage device 131 is coupled to the IO bus 130. The data storage device 131 may be a hard disk drive, a floppy disk drive, a CD-ROM device, a flash memory device or other mass storage device. According to an embodiment of the computer system 100, the data storage device 131 includes a plurality of sectors for storing data. The sectors may be referenced by using logical block addressing (LBA). Data files may be stored on one or more sectors where the sectors may be either contiguous or non-contiguous sectors in the data storage device 131.

According to an embodiment of the present invention, an input output monitor 114 may be implemented to determine whether a request to access more than one non-contiguous sectors in the data storage device 131 is made by an entity having privilege, to determine whether the more than one non-contiguous sectors are protected, and to grant the request to access the more than one non-contiguous sectors in response to determining whether the entity has privilege and whether the data in the more than one non-contiguous sectors is protected. According to one embodiment, the input output monitor 114 may be implemented as software and reside in the memory 113. It should be appreciated that the input output monitor 114 may be implemented using other techniques and procedures and may reside in other locations.

An input interface 132 is coupled to the IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from the input device to the computer system 100.

A bus bridge 123 couples IO bus 120 to IO bus 130. The bus bridge 123 operates to buffer and bridge data signals between IO bus 120 and IO bus 130. The bus bridge 123 includes a bus controller 124. The bus controller 124 controls IO bus 130 by executing a schedule of tasks provided.

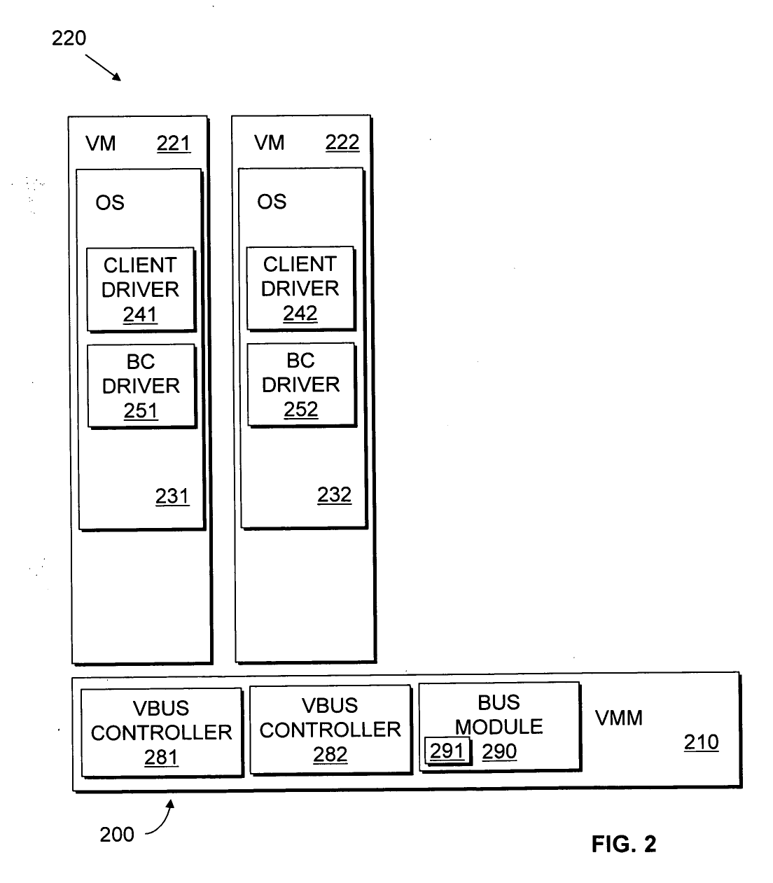

FIG. 2 is a block diagram that illustrates a virtualized environment 200 according to a first embodiment of the present invention. The virtualized environment 200 includes a VMM 210. The VMM 210 provides an interface to a physical machine. The physical machine may include components of a computer system such as, for example, one or more processors, a memory, buses, a bus controller, and various IO devices. According to an embodiment of the present invention, the physical machine may be implemented by the computer system 100 shown in FIG. 1 or a computer system having components similar to those shown in FIG. 1. The VMM 210 facilitates one or more VMs 220 to be run. According to an embodiment of the present invention, the VMM 210 may be a sequence of instructions stored in a memory of a computer system. The VMM 210 manages and mediates computer system resources in the physical machine between the VMs 220 and allows the isolation of or data sharing between VMs 220. The VMM 210 achieves this isolation or sharing by virtualizing resources in the physical machine and exporting a virtual hardware interface (i.e., a VM) that could reflect an underlying architecture of the physical machine, a variant of the physical machine, or an entirely different physical machine. The VMM 210 includes a plurality of virtual bus (VBUS) controllers 281 and 282. The virtual bus controllers 281 and 282 are presented to VMs in the virtualized environment 200. VMs in the virtualized environment 200 communicate with the virtual bus controllers 281 and 282 as if they were the actual bus controller in the physical machine.

The VMM 210 includes a bus module 290. The bus module 290 may include a sequence of instructions and associated memory. The bus module 290 controls the bus controller in the physical machine and maintains a schedule, called the active schedule that is executed by the bus controller. According to an embodiment of the virtualized environment, the bus module 290 traps accesses made by VMs to the virtual bus controllers 281 and 282. The bus module 290 may implement the semantics of registers, update the state of the virtual bus controllers 281 and 282, and return status of the virtual bus controllers 281 and 282. The bus module 290 may also trap accesses to pages that include a schedule. These traps may be implemented as page faults, for example. The pages may include a periodic frame list, queue heads (QHs), and/or transfer descriptors (TDs). When a VM updates QHs or TDs, the bus module 290 updates the active schedule. Status information from the active schedule in the USB module 290 may be copied back into a schedule in a VM. The bus module 290 may also generate interrupts in the VM as required by the state of a virtual bus controller.

The bus module 290 includes an input output monitor 291. According to an embodiment of the bus module 290, the input output monitor 291 determines whether a request to access sectors in an input output device such as a data storage device is made by an entity having privilege and whether the sectors are protected. The sectors may be arranged and referenced using logical block addressing or other techniques. The input output monitor 291 may grant the request to access in response to whether the entity has privilege and whether the sectors are protected. The data may be stored in more than one contiguous or non-contiguous sectors in a data storage device such as a hard disk, CD-ROM or other device. It should be appreciated that the input output monitor 291 may also operate to initiate or modify the protection of the sectors for future access. For example, the input output monitor 291 may impose locking options which would restrict reading from and/or writing to the sectors. The input output monitor 291 may also encrypt data in the sectors.

The virtualized environment 200 includes one or more VMs 221-222 (collectively shown as 220). According to an embodiment of the present invention, the VMM 210 has control of the physical machine and creates VMs 220, each of which behaves like a physical machine that can run its own operating system (OS). VMs 221-222 may run operating systems (guest operating systems) 231-232 respectively where the operating systems 231-232 may be unique to one another. One or more applications (guest applications) may be run on each of the VMs 221-222.

The VMs 221 and 222 include client drivers 241 and 242 respectively. The client drivers 241 and 242 support input output devices coupled to an input output bus. The client drivers 241 and 242 generate IO requests to access the input output devices.

The VMs 221 and 222 include bus controller (BC) drivers 251 and 252 respectively. The bus controller drivers 251 and 252 interface with virtual bus controllers 281 and 282, respectively. Each bus controller driver sets up a schedule for its virtual bus controller to execute. The schedule may include TDs and/or QHs that describes activities on each frame of the bus associated with the bus controller. According to an embodiment of the present invention, the bus controller drivers 251 and 252 generate a schedule for the bus controller that includes both isochronous data and asynchronous data.

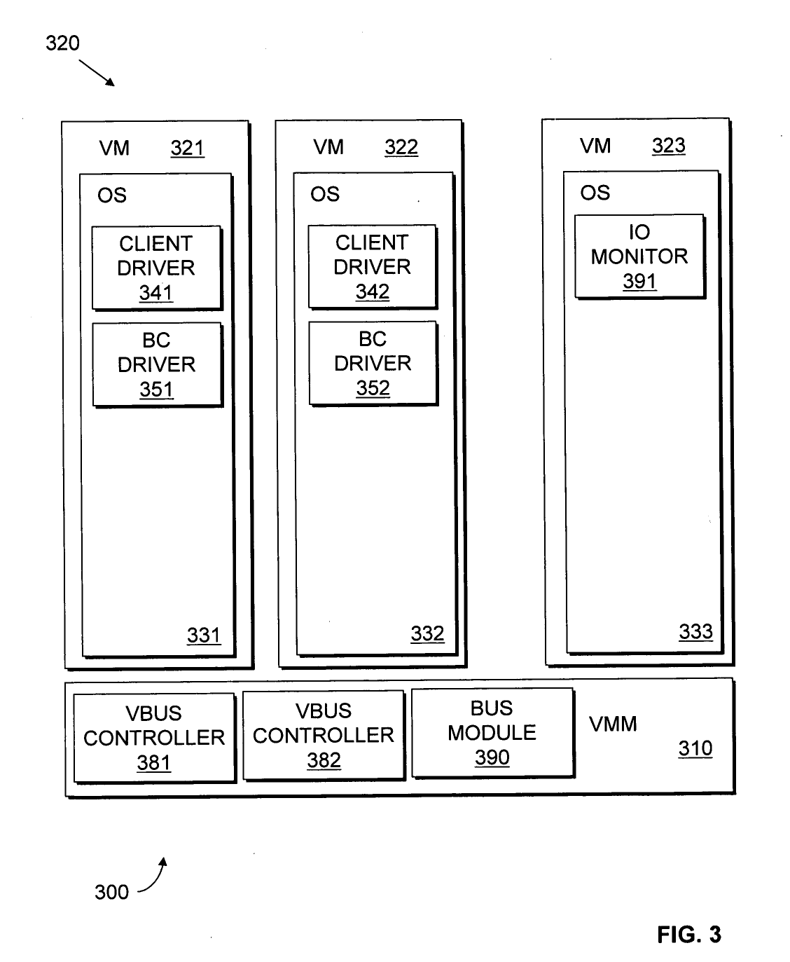

FIG. 3 is a block diagram that illustrates a virtualized environment 300 in which an embodiment of the invention resides according to a second embodiment. The virtualized environment 300 includes a VMM 310 and VMs 321 and 322. According to an embodiment of the present invention, the VMM 310 and VMs 321 and 322 may include some properties that are similar to and perform some procedures that are similar to those described with respect to the VMM 210 and VMs 221 and 222 in FIG. 2.

The virtualized environment 300 includes a VM 323 that operates as a dedicated service VM. According to an embodiment of the virtualized environment 300, the service VM 323 supports an input output monitor 391. The input output monitor 391 may include some properties that are similar to and perform some procedures that are similar to those described with respect to the input output monitor 291 in FIG. 2. Instead of operating in a VMM, the input output monitor 391 operates as a driver in a service VM 323 run on the VMM 310.

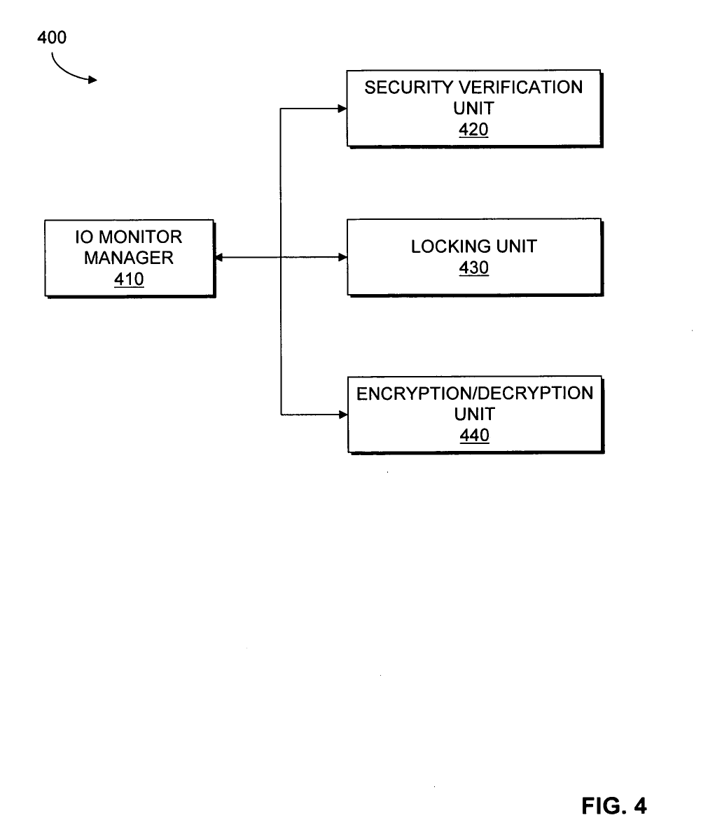

FIG. 4 is a block diagram that illustrates an input output monitor 400 according to an embodiment of the present invention. The input output monitor 400 may be used to implement the input output monitor 291 or input output monitor 391 (shown in FIGS. 2 and 3) according to an embodiment of the present invention. The input output monitor 400 includes an input output (IO) monitor manager 410. The input output monitor manager 410 determines whether a request to access sectors in an input output device such as a data storage device is made by an entity having privilege. The sectors may include one or more contiguous or non-contiguous sectors. The sectors may be referenced by using logical block addressing or other techniques. According to an embodiment of the input output monitor 400, privilege may be determined by user login and password confirmation, key verification, and/or other procedure. The input output monitor manager 410 is also connected to and transmits information between the components of the input output monitor 400.

The input output monitor 400 includes a security verification unit 420. The security verification unit 420 determines whether the sectors are protected. The sectors may be protected if the sectors are access controlled. Sectors may be access controlled, for example, if reading and/or writing restrictions are present. The sectors may also be protected if data in the sectors have been encrypted by the input output monitor 400. The security verification unit 420 may grant the request to access if the sectors are not protected.

The input output monitor 400 includes a locking unit 430. The locking unit 430 may grant the request to access if accessing the sectors does not trigger an access violation. The locking unit 430 may also modify locking options that manage the access control of the sectors. For example, if the request to access is made by an entity having privilege, and granting the request would trigger an access violation, the locking unit 430 may modify the locking options such that the sectors are no longer read and/or write only. According to an embodiment of the input output monitor 400, the locking unit 430 may restore the locking options after the modification such that a future request to access the sectors is subject to access control.

The input output monitor 400 includes an encryption/decryption unit 440. The encryption/decryption unit 440 determines whether data in the sectors is encrypted. If the data is encrypted and if the request to access the sectors is made by an entity having privilege, the encryption/decryption unit 440 decrypts the data. The encryption/decryption unit 440 may grant the request to access the sectors after decrypting the data or upon determining that the data is not encrypted.

According to an embodiment of the present invention, the input output monitor unit 400 may also be used to initiate protection of sectors for future access when requested by an entity with privilege. For example, the locking unit 430 may set locking options to control access to sectors, such as making it read and/or write only. The encryption/decryption unit 440 may also operate to encrypt data in the sectors. Encryption of the data provides further protection of the sectors in the event that the data storage device is removed from a computer system and the input output monitor 400 is unable to enforce access restriction to the protected sectors.

By implementing the input output manager 291/391 in a virtual machine monitor or a driver in a virtual machine, management of sectors in a data storage device is no longer limited to having the data storage devices connected to a particular controller or other hardware component. The data storage device may be connected anywhere in a computer system and sectors on the data storage device can still be protected with access control and encryption.

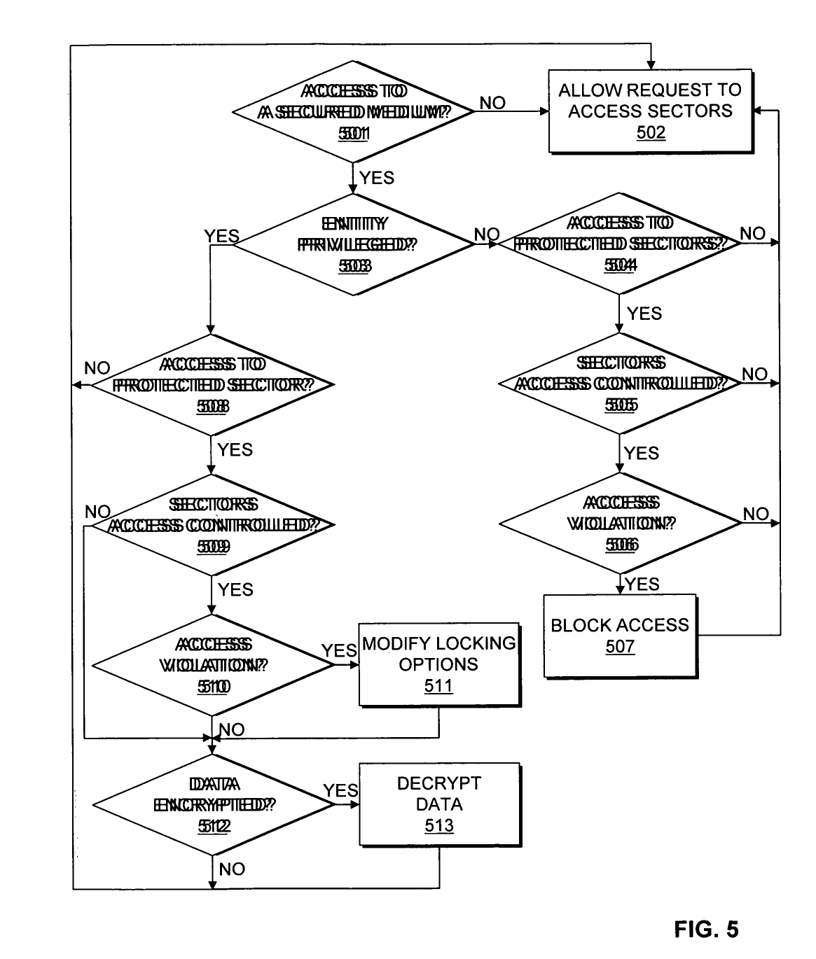

FIG. 5 is a flow chart illustrating a method for managing access to an input output device according to a first embodiment of the present invention. At 501, it is determined whether a request to access sectors in an input output device requires accessing a secured medium. A secured medium may be a data storage device that is designated as being protected. The secured medium may have sectors that may be subject to access control and/or data written therein that is encrypted by an input output monitor. The sectors may include one or more contiguous or non-contiguous sectors in the data storage device referenced using logical block addressing or other techniques. If it is determined that the request to access does not require accessing a secured medium, control proceeds to 502. If it is determined that the request to access requires accessing a secured medium, control proceeds to 503.

At 502, the request to access is granted.

At 503, it is determined whether the entity initiating the request is privileged. According to an embodiment of the present invention, privilege may be determined by user login and password confirmation, key verification, and/or other procedures. If it is determined that the entity initiating the request is not privileged, control proceeds to 504. If it is determined that the entity initiating the request is privileged control proceeds to 508.

At 504, it is determined whether the sectors are protected. According to an embodiment of the present invention, sectors are considered protected if the sectors are subject to access control or if the sectors include data that is encrypted by an input output monitor. If it is determined that the sectors are not protected, control proceeds to 502. If it is determined that the sectors are protected, control proceeds to 505.

At 505, it is determined whether the sectors are access controlled. If it is determined that the sectors are not access controlled, control proceeds to 502. Although data stored in the sector may be encrypted, because the entity making the request is not privileged, the data is not made available to the entity on a request to read in its clear form. If it is determined that the sectors are access controlled, control proceeds to 506.

At 506, it is determined whether granting the request to access would trigger an access violation. According to an embodiment of the present invention, an access violation may occur if there is a request to read from the sectors and a read restriction is in place, or if there is a request to write to the sectors and a write restriction is in place. If it is determined that granting the request would not trigger an access violation, control proceeds to 502. If it is determined that granting the request would trigger an access violation, control proceeds to 507.

At 507, the request to access is blocked.

At 508, it is determined whether the sectors are protected. According to an embodiment of the present invention, sectors are considered protected if the sectors are subject to access control or if the sectors include data that is encrypted by an input output monitor. If it is determined that the sectors are not protected, control proceeds to 502. If it is determined that the sectors are protected, control proceeds to 509.

At 509, it is determined whether the sectors are access controlled. If it is determined that the sectors are not access controlled, control proceeds to 512. If it is determined that the sectors are access controlled, control proceeds to 510.

At 510, it is determined whether granting the request to access would trigger an access violation. If it is determined that granting the request would not trigger an access violation, control proceeds to 512. If it is determined that granting the request would trigger an access violation, control proceeds to 511.

At 511, locking options that manage access control are modified. According to an embodiment of the present invention, the locking options are modified to allow access to the sectors. The locking options may be restored after access to allow future requests to access to be controlled.

At 512, it is determined whether data written in the sectors is encrypted by an input output manager. If it is determined that the data written in the sectors is encrypted by the input output manager, control proceeds to 513. If it is determined that the data written in the sectors is not encrypted by the input output manager, control proceeds to 502.

At 513, the data is decrypted. Control proceeds to 502.

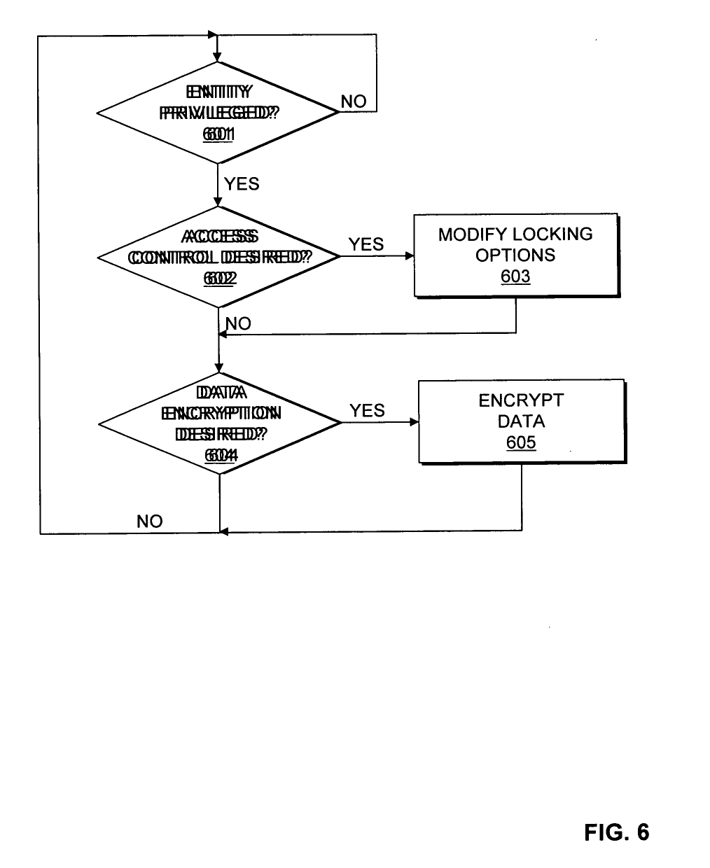

FIG. 6 is a flow chart illustrating a method for managing access to an input output device according to a second embodiment of the present invention. At 601, it is determined whether an entity is privileged. According to an embodiment of the present invention, privilege may be determined by user login and password confirmation, key verification, and/or other procedures.

At 602, it is determined whether access control to sectors in the input output device is desired. The sectors may include one or more contiguous or non-contiguous sectors in the input output device. If access control is desired, control proceeds to 603. If access control is not desired, control proceeds to 604.

At 603, locking options may be modified to provide access control. According to an embodiment of the present invention, access control may provide read and/or write only restrictions to selected sectors. The selected sectors may be one or more contiguous or non-contiguous sectors.

At 604, it is determined whether encryption to data in the sectors in the input output device is desired. If encryption is desired, control proceeds to 605. If encryption is not desired, control returns to 601.

At 605, data written to the selected sectors are encrypted. The selected sectors may be one or more contiguous or non-contiguous sectors. Control returns to 601.

FIGS. 5 and 6 are flow charts illustrating methods according to embodiments of the present invention. Some of the techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification embodiments of the invention has been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

What is claimed is:

1. A method for managing access to a data storage device, comprising:
determining whether a request to access more than one non-contiguous sectors in the data storage device is made by an entity having privilege;
determining whether the more than one non-contiguous sectors is protected; and
granting the request to access the more than one non-contiguous sectors in response to determining whether the entity has privilege and whether the data in the more than one non-contiguous sectors is protected.

2. The method of claim 1, wherein determining whether the more than one non-contiguous sectors is protected comprises determining whether granting the request to access would trigger an access violation.

3. The method of claim 1, wherein determining whether the more than one non-contiguous sectors is protected comprises determining whether data in the more than one non-contiguous sectors is encrypted.

4. The method of claim 1, wherein granting the request to access comprises modifying locking options.

5. The method of claim 1, further comprising decrypting data stored in the more than one non-contiguous sectors.

6. The method of claim 1, wherein determining whether the request is made by an entity with privilege and whether the more than one non-contiguous sectors is protected is performed by a virtual machine manager.

7. The method of claim 1, wherein determining whether the request is made by an entity with privilege and whether the more than one non-contiguous sectors is protected is performed by a driver in a virtual machine.

8. The method of claim 1, wherein the data storage device is a hard drive.

9. The method of claim 1, further comprising allowing the entity to restrict access to other non-contiguous sectors in the data storage device upon determining that the entity has privilege.

10. The method of claim 1, further comprising allowing the entity to encrypt data stored in the data storage device upon determining that the entity has privilege.

11. An article of manufacture comprising a machine accessible medium including sequences of instructions, the sequences of instructions including instructions which when executed cause the machine to perform:
determining whether a request to access more than one non-contiguous sectors in a data storage device is made by an entity having privilege;
determining whether the more than one non-contiguous sectors is protected; and
granting the request to access in response to determining whether the entity has privilege and whether the data in the more than one non-contiguous sectors is protected.

12. The article of manufacture of claim 11, wherein determining whether the more than one non-contiguous sectors is protected comprises determining whether granting the request to access would trigger an access violation.

13. The article of manufacture of claim 11, wherein determining whether the more than one non-contiguous sectors is protected comprises determining whether data in the more than one non-contiguous sectors is encrypted.

14. The article of manufacture of claim 11, wherein granting the request to access comprises modifying locking options.

15. An input output (IO) monitor, comprising:
an IO monitor manager to determine whether a request to access more than one non-contiguous sectors in a data storage device is made by an entity having privilege; and
a security verification unit to determine whether the more than one non-contiguous sectors are protected.

16. The apparatus of claim 15, further comprising a locking unit to determine whether granting the request to access would trigger an access violation.

17. The apparatus of claim 15, further comprising an encryption/decryption unit to determine whether data in the more than one non-contiguous sectors is encrypted.

18. The apparatus of claim 15, wherein the security verification unit grants the request upon determining that the more than one non-contiguous sectors are not protected.

19. The apparatus of claim 16, wherein the locking unit grants the request upon determining that request to access would not trigger an access violation.

20. The apparatus of claim 17, wherein the encryption/decryption unit decrypts the data when the entity has privilege.
